(19) United States
(12) Patent Application Publication
(10) Pub. No.: US 2012/0056398 A1
(43) Pub. Date: Mar. 8, 2012

(54) SEMI-TRAILER AXLE AND SUSPENSION CONNECTING STRUCTURE

(76) Inventor: Zhiqiang Wu, Guangdong (CN)

(21) Appl. No.: 13/320,543

(22) PCT Filed: Dec. 1, 2009
(86) PCT No.: PCT/CN2009/075233

§ 371 Date: Nov. 15, 2011

(30) Foreign Application Priority Data
Jun. 16, 2009 (CN) 200910040334.0

(51) Int. Cl. B60G 11/27; B60G 9/00

(52) U.S. Cl. 280/124.157; 280/124.1

(57) ABSTRACT

A semi-trailer axle and suspension connecting structure includes an axle (5), a suspension system and a connecting member arranged on the axle (5) body and a suspension support plate (6) of the suspension system. A locating structure is arranged on the match surface of the axle (5) and the suspension support plate (6) to prevent the circumferentially and axially relative displacement between the axle (5) and the suspension support plate (6). The invention omits a welding process for the axle body and the suspension support plate (6). The axle body still keeps a good strength structure while the firm connection of the axle body and the suspension arrives, and the stress damage caused by welding is avoided.

### BACKGROUND OF THE INVENTION

The invention relates to a connection structure for semi-trailer axle and suspension.

A semi-trailer axle and a semi-trailer frame are firmly connected by a suspension system, and leaf spring suspension and air suspension are commonly used at present. The air suspension is better in improving automotive ride performance and comfort than the leaf spring suspension, improves the transporting safety of cargo, reduces the damage to road surface and is favorable to road maintenance, thereby gradually getting more popularity. On current international market of semi-trailers, the connection structure for suspension and axle basically adopts a U-shaped screw bolt for firm clamping, and then the axle is fixed on the suspension system by means of welding to prevent rotation and axial movement of the axle. Basically, air suspension is connected to the semi-trailer axle by welding, some manufacturers use a U-shaped screw bolt to connect the both based on welding, such connection mode has the disadvantage that the torsional strength and the flexural strength of the axle are reduced at the welding position of the axle body, so the service life of the axle is reduced, especially when the semi-trailer rides on a rough road, the axle body is liable to crack, and even fail to work around the welding position under the joint action of a bending moment and a torsional moment.

### BRIEF SUMMARY OF THE INVENTION

In view of the technical defects of the prior art of welding connection between suspension and axle, the technical matter of the invention required to be solved is to provide a axle-suspension fixing connection structure capable of completely meeting requirements of axle strength, which does not need welding fixing and will not weaken the axle strength, and the connection is firm and reliable.

The invention employs the following technical scheme to solve the technical problem: a connection structure for semi-trailer axle and suspension includes an axle, a suspension and connecting member arranged on an axle body and a suspension support plate of the suspension system; and a positioning structure for preventing circumferential or axial relative displacements between the axle and the suspension support plate is disposed on the fitting surface of the axle and the suspension support plate.

In said connection structure, the positioning structure has the following structure: a positioning slot is pressing-molded on the axle, the edge of the positioning slot forms a flange higher than outside diameter of the axle; the fitting surface of the suspension support plate is provided with a positioning bump fitted with the positioning slot, and the flange of the positioning bump corresponding to the positioning slot has a clearance.

The positioning structure further comprises that: the part of the inner side of the axle corresponding to the positioning slot has a concave deformation.

The axle body fitted with the suspension support plat is a square tube axle body or a round tube axle body.

The positioning slot is 4-8 mm in depth, preferably 5-6 mm, and is 15-20 mm in width. The flange of the edge of the positioning slot is 1-2 mm high.

The connecting member for the axle body and the suspension system is a U-shaped screw bolt.

Furthermore, said suspension system is an air suspension using a gas spring.

The invention has the following advantages that:

The connection structure of the invention does not need a working procedure of welding the axle body and the suspension support plate because of having the positioning structure in which the positioning bump on the fitting surface of the suspension support plate is fitted with the positioning slot on the axle, still makes the axle body keep a good strength structure while achieving a firm connection between the axle body and the suspension and prevents stress damage caused by welding; the flanges of both sides of the positioning slot effectively ensure the working height of the positioning slot, and such structure is molded by pressing and avoids the influence of machining modes such as milling groove and the like on the axle strength; the axle of the invention has superior mechanical performances; and compared with the prior welding structure, the fatigue life of the axle is prolonged by more than 20 percent. The effect is very obvious.

### BRIEF DESCRIPTION OF THE DRAWINGS

FIG. 1 is a structural diagram of the preferred embodiment of the invention;

FIG. 2 is a sectional view of A part of FIG. 1, which is one structure of the positioning structure of the invention for preventing circumferential and axial relative displacements between the axle and the suspension support plate;

FIG. 3 is a structural diagram of the axle body with a positioning slot; and

FIG. 4 is a sectional view of another structure of the positioning structure for preventing circumferential and axial relative displacements between the axle and the suspension support plate.

### DETAILED DESCRIPTION OF THE INVENTION

The invention is further described by taking an air suspension for example.

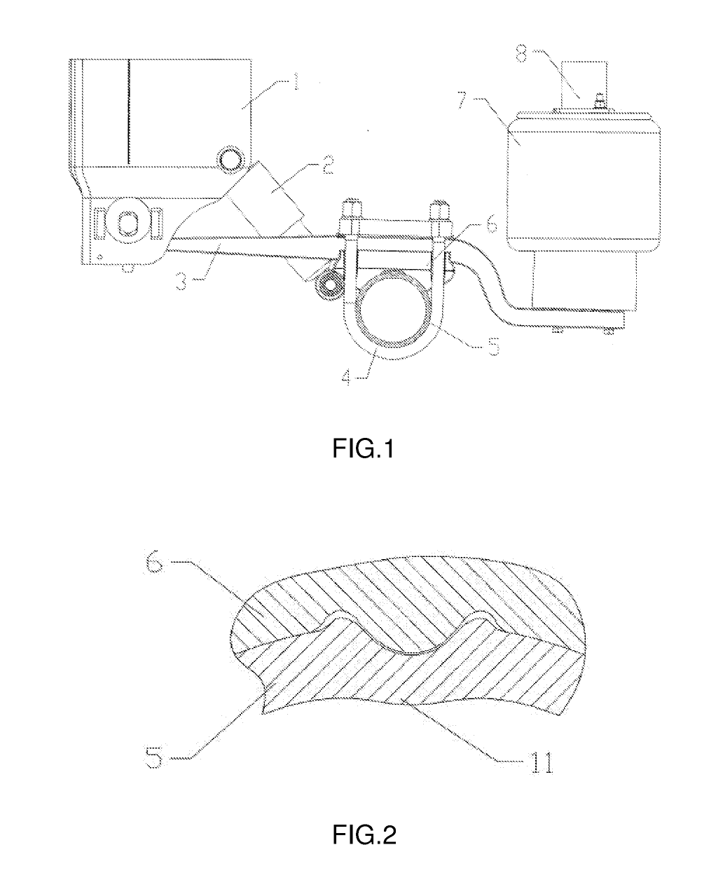

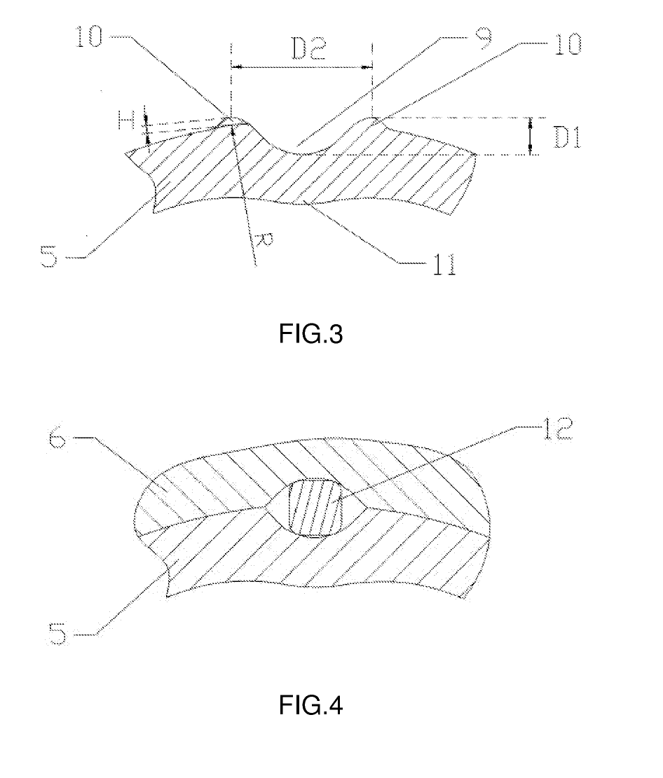

Referring to FIG. 1 and FIG. 2, an air suspension system comprises the following major parts: a front bracket 1, a rear bracket 8, a shock absorber 2, a leaf spring 3, a gas spring 7 and a suspension support plate 6. The suspension system is the air suspension using a gas spring, and the axle 5 is fixed on the suspension support plate 6 by a U-shaped screw bolt 4 to realize a connection between the axle and the suspension. In order to prevent circumferential and axial relative displacements between the axle and the suspension, i.e. rotation and axial movement of the axle body relative to the suspension support plate, a positioning structure for preventing the axle 5 and the suspension support plate 6 from having circumferential and axial relative displacements is disposed on the fitting surface of the axle 5 and suspension support plate 6. The positioning structure is formed through the following steps: a positioning slot 9 is pressing-molded on the axle 5, the shell of the positioning slot 9 is obtained by cold pressing or heating forging, the edge of the positioning slot 9 rises and forms a flange 10 slightly higher than the outside diameter of the axle during pressing, such that the working height of the slot and a positioning block is ensured. After positioning slot pressing is completed, the part of the inner side of the axle corresponding to the positioning slot 9 is indented and deformed to form an internally convex part 11, and the deformation slope is smaller than the depth of the positioning slot 9 so as to meet the requirement of axle strength as shown in FIG. 2 and FIG. 3. In the scheme, the depth D1 of the positioning slot 9 is 4-8 mm, preferably 5-6 mm, and herein the depth of the positioning slot 9 is the distance between the lowest point of the bottom of the positioning slot 9 and the highest point of the flange 10; the width D2 of the positioning slot 9 is 15-20 mm, which is the radial width of the positioning slot and is the distance between the highest pointes of the flanges 10 of both sides of positioning slot; and the height H of the flange 10 is controlled within 1-2 mm, which is obtained by subtracting the radius R of the unmachined axle 5 from the distance between the highest point of the flange 10 and the axle center of the axle 5. A positioning bump fitted with the positioning slot is arranged on the fitting surface of the suspension, and the flange of the positioning bump corresponding to the positioning slot has clearance design. The radial shape of the positioning slot 9 effectively prevents circumferential relative displacements between the axle and the suspension, there is no limitation for the radial length of the positioning slot 9, the positioning slot is molded by pressing a shell according to the practical welding length, and the structure of the positioning slot 9 in length can effectively prevent axial relative displacement between the axle and the suspension.

In the invention, the positioning structure for preventing circumferential and axial relative displacements between the axle and the suspension support plate can be designed into the following structure: a slot structure is pressing-molded on the position connected with both the axle 5 and the suspension support plate 6, the circumferential or axial relative displacements between the axle 5 and the suspension support plate 6 can be prevented only by mounting a positioning lever pin 12 in the slot when the axle 5 and the suspension support plate 6 are assembled, and the positioning lever pin 12 can be replaced by a key.

In the technical scheme, the positioning block on the suspension support plate can be contained in the positioning slot on the axle body, such that a firm connection between the air suspension and the axle body can be ensured during the use of the axle, and the rotation and movement of the axle relative to the suspension is prevented.

In the invention, the positioning slot pressing-molded on the axle body can be applied on a square axle as well as a round axle.

1. A connection structure for semi-trailer axle and suspension includes an axle, a suspension and connecting member arranged on an axle body and a suspension support plate of the suspension system; and a positioning structure for preventing circumferential or axial relative displacements between the axle and the suspension support plate is disposed on the fitting surface of the axle and the suspension support plate.

2. The connection structure according to claim 1, wherein a positioning slot is pressing-molded on the axle, the edge of the positioning slot forms a flange higher than outside diameter of the axle; the fitting surface of the suspension support plate is provided with a positioning bump fitted with the positioning slot, and the flange of the positioning bump corresponding to the positioning slot has a clearance.

3. The connection structure according to claim 2, wherein the positioning structure further comprises that: the part of the inner side of the axle corresponding to the positioning slot has a concave deformation.

4. The connection structure according to claim 3, wherein the axle body fitted with the suspension support plat is a square tube axle body.

5. The connection structure according to claim 3, wherein the axle body fitted with the suspension support plat is a round tube axle body.

6. The connection structure according to claim 5, wherein the positioning slot is 4-8 mm in depth, 15-20 mm in width.

7. The connection structure according to claim 6, wherein the flange of the edge of the positioning slot is 1-2 mm high.

8. The connection structure according to claim 6, wherein the positioning slot is in width 5-6 mm preferably.

9. The connection structure according to claim 6, wherein the connecting member for the axle body and the suspension system is a U-shaped screw bolt.

10. The connection structure according to claim 5, wherein said suspension system is an air suspension using a gas spring.

11. The connection structure according to claim 7, wherein the connecting member for the axle body and the suspension system is a U-shaped screw bolt.

12. The connection structure according to claim 8, wherein the connecting member for the axle body and the suspension system is a U-shaped screw bolt.
